(19) United States
(12) Patent Application Publication
(10) Pub. No.: US 2020/0367329 A1
(43) Pub. Date: Nov. 19, 2020

(54) NEAR-FIELD MONITORING OF ENERGY DELIVERY

(71) Applicant: HEWLETT-PACKARD DEVELOPMENT COMPANY, L.P., Spring, TX (US)

(72) Inventors: David A Champion, Corvallis, OR (US); Raymond Adamic, Corvallis, OR (US); James Abbott, Corvallis, OR (US); Gilberto Ribeiro, Belo Horizonte (BR); Cassio Goncalves, Belo Horizonte (BR); Diego Tami, Belo Horizonte (BR); Wellington Avenlino, Corvallis, OR (US); Douglas Pederson, Corvallis, OR (US)

(21) Appl. No.: 16/608,339

(22) PCT Filed: Jan. 31, 2018
(86) PCT No.: PCT/US2018/016323

§ 371 Date: Oct. 25, 2019

(51) Int. Cl. H05B 6/80; B22F 3/105

(52) U.S. Cl. CPC H05B 6/802; B22F 2003/1054; B22F 3/105

(57) ABSTRACT

A MW signal is delivered to a waveguide with a coaxial concentrator. At least one of an amplitude and a phase of a reflected signal from the coaxial concentrator is monitored to determine material characteristics of a build material fusion process.

### BACKGROUND

Additive manufacturing is becoming more prevalent with the development of 3D printing, rapid prototyping, and direct digital manufacturing systems that create 3D objects by adding layers of materials. The materials may include, for example, plastic, metal, ceramic, glass, or graphite.

### BRIEF DESCRIPTION OF THE DRAWINGS

The disclosure is better understood regarding the following drawings. The elements of the drawings are not necessarily to scale relative to each other. Rather, the emphasis has instead been placed upon illustrating the claimed subject matter. Furthermore, like reference numerals designate corresponding similar parts through the several views. For brevity, reference numbers used in later drawings that are repeated may not be re-described.

FIG. 1 is a cross-section of an example waveguide for near-field monitoring of energy delivery;

FIG. 2 is a block diagram of an example system using a waveguide with an example microwave (MW) source and example phase and amplitude detector for near-field monitoring of energy delivery;

FIG. 3 is a block diagram of an example 3D printing system using near-field monitoring of energy delivery;

FIG. 4 is an image of a layer of metal powder and an example application of a spot MW energy to create an example fused area;

FIG. 5 is a graph of an example coupling vs. MW frequency for an example waveguide;

FIG. 6A is a flowchart of an example method for near-field monitoring of energy delivery;

FIG. 6B is a flowchart of additional operations which may be included in the example method of FIG. 6A;

FIG. 7A is a block diagram of example instructions for a non-transitory computer readable medium;

FIG. 7B is a block diagram of additional example instructions for the computer-readable medium of FIG. 7A; and

FIG. 8 is a graph showing example relative amplitude and phase changes of a difference signal during different fusion process states.

### DETAILED DESCRIPTION

One of the challenges, with some kinds of additive manufacturing techniques, is to accurately deliver energy in small regions using an appropriate energy source with both precision and minimum dispersion. Current systems may apply a layer of build material and precisely apply a fusing agent with a liquid-jet system and then may apply a broad spectrum I/R radiation source or scanner laser energy source that is absorbed by the fusing agent to heat and fuse the build material. The build material may be one of various metal, glass, graphite, plastic, ceramic, powder-like materials, and other material powders. Other build materials may include short fibers within the build materials to ensure the definition of processed build material. For instance, in some examples the powder may be formed from or may include, short fibers that may, for example, have been cut into short lengths from long strands or threads of material. Some current systems may use a laser energy source which can focus down to about 1 wavelength of the laser radiation frequency. While a laser energy source may be steered and not contact the build material, it operates in a far-field operation, and it has been difficult to create feedback loops for monitoring the reflected light of opaque and granular materials due to diffuse scattering. This diffuse scattering does not allow for far-field phase monitoring of the laser. Further, due to the far-field operation, such laser 3D systems receive continual maintenance to prevent dust contamination. Such dust contamination limits high power operation of a laser energy source. Further, near-field wavelengths for laser energy sources are in the nanometer distances whereas for MW sources the wavelengths are in the millimeter distances. Accordingly, it is not believed possible to have near-field monitoring with laser energy source processes.

In contrast, this disclosure describes delivering microwave (MW) energy in precise spots to a build material using a waveguide having a coaxial concentrator for near-field MW energy delivery and monitoring. This MW energy may be absorbed by the build material itself causing it to heat, sinter, and fuse by melting. In some example, a MW absorbing fusing agent, such as a MW absorbing power or a mix with other MW absorbing powders, may also be applied to help with materials that do not have good inherent MW absorption. The waveguide has a transmitting antenna receiving a buffered MW signal and a receiving antenna coupled to the coaxial concentrator. During fusion of layered build material, a portion of the buffered MW signal is reflected from the coaxial concentrator back to the transmitting antenna due to an interaction of the buffered MW energy delivery to the build material. As the powdered build material is heated and fused, the reflection received back at the transmitting antenna changes in relative phase and amplitude to the transmitted buffered MW signal. In one example, a heterodyne circuit may be coupled to an unbuffered MW signal and the transmitting antenna and used to create a difference signal to represent a reflected signal. The difference is between the unbuffered MW signal and the combined buffered MW signal and reflected signal(s). The phase and amplitude of the difference signal may be analyzed to determine the fusion state of the build material.

This near-field monitoring of the MW energy delivery using the reflected signal has capabilities over far-field monitoring with far-field laser energy sources, I/R temperature sensors, and optical cameras due primarily to the ability of far-field monitoring to be limited to one-quarter of the wavelength of the laser, I/R, or optical monitoring signals, respectively. The described near-field monitoring technique described within allows for monitoring of energy delivery in lateral dimensions of about 1/1000th of a wavelength of the buffered MW energy signal. This precision monitoring allows energy delivery of more than 2 orders of magnitude of improvement over far-field techniques. Furthermore, the phase and amplitude of the difference signal can be correlated with far-field I/R temperature sensing to allow the difference signal also to provide more rapid temperature monitoring as well as various states of the build material fusion process, such as powdered, sintered, and full melt states. The disclosed waveguide and near-field monitoring may be used in sintering, welding, 3D printing, and other applications to provide precision energy delivery of high electric fields with negligible magnetic fields. Other example waveguides may be used including those that provide more magnetic field. For instance, with metallic systems the ratio of the magnetic and electric components may impact the crystal formation. Eddy currents that may be stimulated in metal by the magnetic portion of the MW field may amorphize a crystalline metal lattice under certain experimental conditions. The magnetic component of the EM wave may also tend to penetrate deeper into an electrically conductive medium allowing for longer range control of final materials properties. Accordingly, alternate geometries for the MW waveguide enhancing magnetic fields could expand the application space of this technique, with additional levels of excitation and control. Thus, the structure and design of the disclosed MW waveguide are not meant to be limiting but used as just one example waveguide for conciseness and ease of understanding. More detail follows below in the description of the drawings.

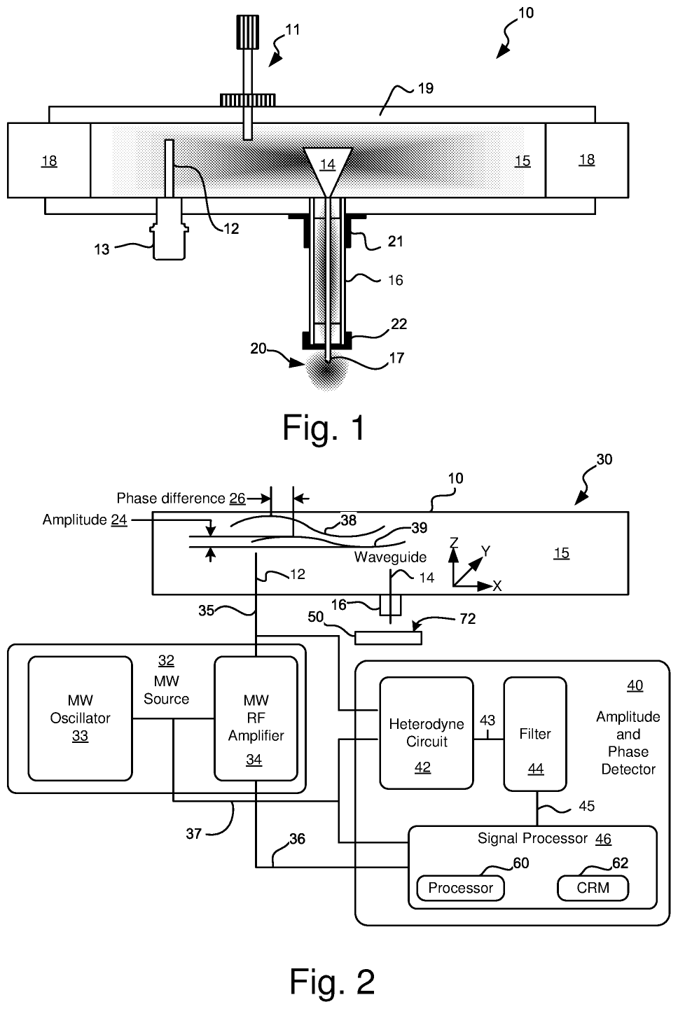

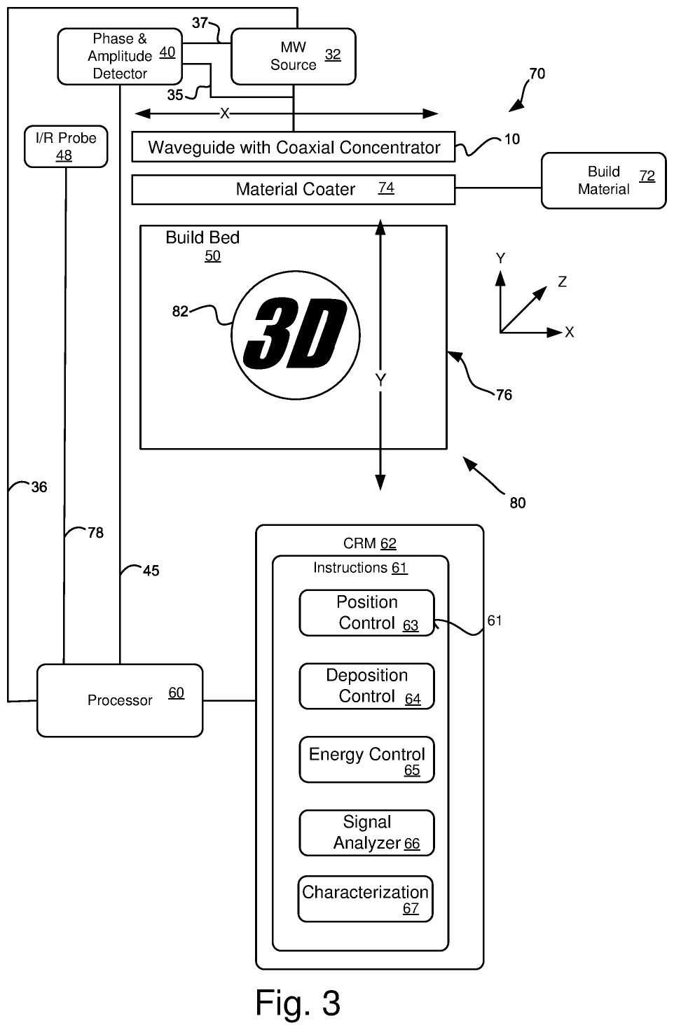

FIG. 1 is a cross-section of a waveguide 10 for near-field monitoring of energy delivery. The waveguide 10 includes an enclosure 19 with a cavity 15, a pair of tuning shorts 18 at opposing ends of the cavity 15, an RF connector 13 coupled to a transmitting antenna 12, and a receiving antenna 14 coupled to a coaxial concentrator 16. In this example, the coaxial concentrator 16 is attached to waveguide 10 with mount 21. The coaxial concentrator has a probe wire extending from antenna 14 to a tip 17. The cavity 15 may be tuned for a particular MW frequency by the positioning of tuning shorts 18 and an impedance matching screw 11 to adjust coupling of a MW signal transmitted by transmitting antenna 12 to receiving antenna 14. The received MW energy captured by receiving antenna 14 is coupled to the tip 17 through an orifice, such as iris 22. Iris 22 may adjust the opening of the orifice that tip 17 extends through to balance the power delivered to high electric field 20 while adjusting the magnetic field at the tip 17. That is, a larger iris 22 opening allows for a larger high electric field 20 to be present without arcing with a corona discharge to the iris 22. A smaller iris 22 opening restricts the magnetic field that can escape through the opening of iris 22. Accordingly, the coaxial concentrator 16 may have an iris 22 that is adjustable to different orifice sizes. For metal materials, it may be desirable to have as small a magnetic field as possible to prevent crystal formations of the build material. With certain build materials, a larger electric field may shorten the amount of time needed to fuse the build material. Other build materials may be more absorptive of high magnetic fields. In this example, the tip 17 allows for focusing the electric field MW energy onto small regions, typically about 1/1000^{th} of a wavelength of the MW signal or better with very low insertion loss, such as less than about 0.3 dB, and excellent coupling of about 40 dB or better. Accordingly, delivering high electric field energy 20 to the build material (72, FIG. 3) in regions of lateral dimensions of about 1/1000th of the MW signal (50, FIG. 2) at penetration depths up to about 100 to 200 micrometers with a negligible magnetic field. An empirical example of coupling in a prototype waveguide 10 is shown in FIG. 5.

The coaxial concentrator 16 may have a length chosen to maximize the high electric field 17 at the tip 17. In one example as shown, the coaxial concentrator 16 is disposed substantially in the center of the waveguide 10 cavity 15 where the electric field is concentrated in certain modes depending on the resonant frequency of the cavity 15. The iris 22 may also be used to improve the field distribution of the high electric field 20. The waveguide 10 and coaxial concentrator 16 are configured for creating a small spot size of high electric field 20. In this example, the high electric field 20 and negligible magnetic field allows for greater selectivity and use of various build materials. The high electric field 20 allows for relatively low power operation of about 100 Watts for the fusing operation and provides a low penetration depth of less than about 100 to 200 micrometers, limited by heat conduction of the build material being used.

The enclosure 19 of waveguide 10 may have a hollow cavity 15 filled with air or evacuated with a vacuum. Alternatively, in some examples, the cavity 15 may be filled with a high dielectric material to reduce overall dimensions by the square root of the dielectric constant of the high dielectric material. For instance, a 3× reduction in size is possible when using alumina (Al₂O₃) as the high dielectric material, which has a dielectric constant of about 9. Further reduction of the waveguide 10 and its cavity 15 may be done by use of even higher dielectric materials and the use of higher MW frequencies.

The enclosure 19 of waveguide 10 is a guiding structure which may be rectangular, cylindrical, or elliptical in cross-section. The guiding structure allows for the coupling of an excitation signal 38 (FIG. 2) from transmitting antenna 12 to receiving antenna 14 and on to tip 17 via the coaxial concentrator 16. The guiding structure of the enclosure 19 may contain one or more adjustable shorts or mirrors (such as tuning shorts 18), or any tuning stub of sorts. These shorts allow for precise frequency tuning. One or more impedance matching screws 11 with adjustment may be used to match the output impedance for maximum power transfer. For example purposes only, the electric field intensity within cavity 15 is shown in shading, and as well as shading in coaxial concentrator 16. The enclosure 19 and coaxial concentrator 16 outside shield are coupled together through mount 21 and typically grounded.

The RF connector 13 is a port to inject the buffered MW signal 35 into the cavity 15 via transmitting antenna 12 to create an excitation signal 38. In one example, the RF connector 13 is an N-type connector, though others may be used. The transmitting antenna 12 may be a dipole antenna, a conical antenna, a rectangular, spherical, teardrop, or any other geometrical shape that provides an adequate fit for the respective MW excitation signal 38 wavelength. The separation between the transmitting antenna 12 and receiving antenna 14 are congruent with the MW excitation signal 38 wavelength and is defined by the dimensions of the enclosure 19 of waveguide 10 in a deterministic manner.

The coaxial concentrator 16 structure includes an internal conductor coupled to the receiving antenna 14. The receiving antenna 14 may be a dipole antenna, a conical antenna, a rectangular, a spherical, a teardrop, or any geometrical shape that provides an adequate fit for the respective MW excitation signal 38 frequency in the center of the cavity 15 of waveguide 10. At the other end of coaxial concentrator 16, the tip 17 is sharpened to concentrate the electric field through an orifice of iris 22 that aids in impedance matching and magnetic field suppression.

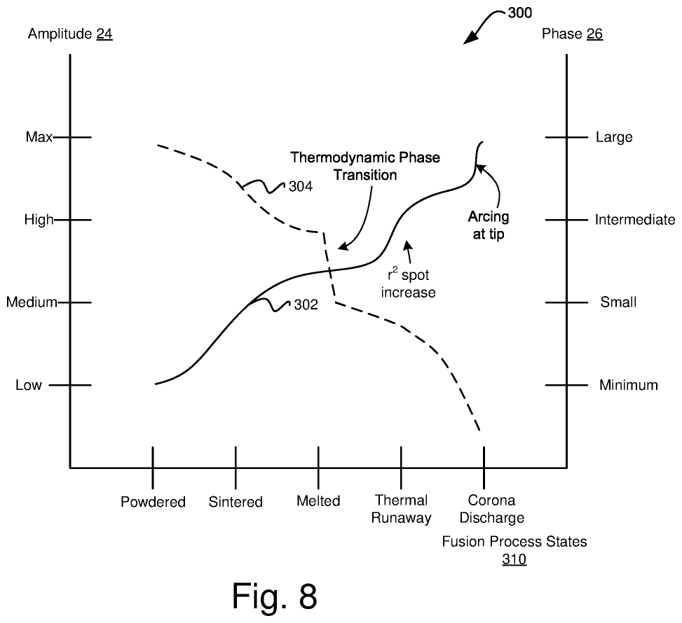

When high electric field 20 is brought in the proximity of build material 72, a portion of the MW excitation signal 38 is reflected (see 39, FIG. 2) along the inner connector of coaxial concentrator 16 to the receiving antenna 14 and transmitted back to and received by the transmitting antenna 12. When the build material is in a powdered form, the MW excitation signal 38 may be scattered due to the various orientations of the powdered material. By superposition of the scattered signals, a combined reflective signal 39 is formed with a respective amplitude 24 (FIG. 2) and phase difference 26 (FIG. 2, also interchangeable with phase 26 where applicable herein). As the powdered build material 72 is heated and begins to melt and fuse, the reflected signal 39 will increase in amplitude 24 relative to the superposition of multiple reflected signals 24 due to the planarization of the melted material forming a somewhat flat reflective surface from the powder build material. Also, as the powder build material 72 aggregates and forms the planarized surface, the phase 26 of the reflected signal 39 will change to being more stable due to more of a single reflection rather than a varying phase signal due to the superposition of multiple reflections 39 from the powdered build material as the particles move and shift from a powdered state to a sintered state to a full melt fused state. Thus, the amplitude 24 and phase 26 of the reflected signal 39 may be used as a near-field monitor of an accumulation state of the build material 72 during the fusion process (see FIG. 8).

FIG. 2 is a block diagram of an example system 30 using a waveguide 10 with an example microwave source 32 and an example phase and amplitude detector 40 for near-field monitoring of MW energy delivery to a working area 50 of build material 72. In this example, the MW source 32 may include a MW oscillator 33 and a MW RF amplifier 34. The MW oscillator 33 provides an unbuffered signal 37, and the MW RF amplifier 34 provides a buffered signal 45 that is substantially impedance matched under normal conditions with the impedance of the waveguide 10 input for maximum power transfer to an excitation signal 38. The transmitting antenna 12 may receive a reflected signal 39 from the tip 17 of coaxial concentrator 16 due to signal reflections and dielectric constant changes in build material 72 that affect the impedance of waveguide 10. The reflected signal 39 has a lesser amplitude 24 and a later phase 26 than the excitation signal 38. However, the amplitude 24 and phase 26 of the reflected signal 39 may vary relative to the excitation signal 38 during operation of a fusing process.

The unbuffered signal 37 of MW oscillator 33 and the buffered signal 45 of the MW RF amplifier 34 are fed to an amplitude and phase detector 40. The buffered MW RF amplifier signal 45 may be reduced in amplitude using various techniques to more closely match the amplitude of the unbuffered MW signal 37 from oscillator 33. The amplitude and phase detector 40 may include a heterodyne circuit 42 to mix the two incoming signals 35, 37 to provide an intermediate frequency with sum and difference signals 43 of the unbuffered signal 37 and the buffered signal 35 with reflection signals 39. A filter 44 may be used to filter out the intermediate frequency and summed signal and provide just a difference signal 45 representing the reflected signal. Other methods may be used to extract the difference signal 45 that reflects the amplitude 24 and phase 26 of the reflected signal 39. A signal processor 46 may be used to digitize the difference signal 45 and the unbuffered signal 37 and perform signal processing algorithms to extract the amplitude 24 and phase 26 of the difference signal 45. The signal processor 46 may also, based on characterization of the how a particular build material 72 transforms into the fused state, determine the state of the fusion process based on the change in one or more of the amplitude 24 and phase differences 26 during the transition to allow for precise control of the MW power delivered to the tip 17 by controlling the output of the MW RF amplifier 34 with power control signal 36.

Signal processor 46 may include one or more processors 60 having one or more cores. Processor 60 may be made of general purpose CPUs, digital signal processor (DSP) CPUs, vector array processors, graphics processors, programmable FPGAs, and the like, or combinations thereof. The processor 60 can read and execute instructions from one or more non-transitory computer-readable mediums 62.

The tangible and non-transitory CRM 62 allows for storage of one or more sets of data structures and instructions 61 (FIG. 3) (e.g., software, firmware, logic) embodying or utilized by any one or more of the methodologies or functions described herein. The instructions 61 may also reside, completely or at least partially, with the static memory, the main memory, and/or within the processor 60 during execution by the system 30. The main memory and the processor memory also constitute CRM 62. The term “computer-readable medium” 62 may include single medium or multiple media (centralized or distributed) that store the one or more instructions or data structures. The CRM 62 may be implemented to include, but not limited to, solid-state, optical, and magnetic media whether volatile or non-volatile. Such examples include, semiconductor memory devices (e.g. Erasable Programmable Read-Only Memory (EPROM), Electrically Erasable Programmable Read-Only Memory (EEPROM), and flash memory devices), magnetic discs such as internal hard drives and removable disks, magneto-optical disks, and CD-ROM (Compact Disc Read-Only Memory) and DVD (Digital Versatile Disc) disks.

Accordingly, a system 30 for near-field monitoring of energy delivery includes a waveguide 10 coupled to a microwave (MW) source 32 at a transmitting antenna 12. The waveguide 10 further includes a receiving antenna 14 coupled to a coaxial concentrator 16. A heterodyne circuit 42 is coupled to the MW source 32 and the transmitting antenna 12 to create a difference signal 45 between the MW source 32 and the transmitting antenna 12 that represents a reflected signal 39 from the receiving antenna 14. A phase and amplitude detector 40 is coupled to the difference signal 45 and configured to output an analysis of a powdered build material 72 various material states during a fusion process. In some examples, the coaxial concentrator 16 may have an iris 22 that is adjustable to different orifice sizes. In various examples, the design of the waveguide 10 and coaxial concentrator 16 may permit a MW buffered signal 35 having a power of less than about 100 to 200 Watts. The MW buffered signal 35 may be coupled to the coaxial concentrator 16 with an insertion loss of less than about 0.3 dB and a coupling of greater than about 40 dB at an excitation signal 38 frequency of the waveguide 10.

FIG. 3 is a block diagram of an example 3D printing system 70 using near-field monitoring of energy delivery. The 3D printing system 70 includes a build bed for building 3D build objects 82 on X-Y plane 76. The build bed 50 may move up/down in the Z direction to allow repetitive layers of powdered build material 72 to be applied on previous layers by a material coater 74 and desired portions fused waveguide 10 with coaxial concentrator 16. Material coater 74 may in one example include a hopper for holding and distributing the build material 72 as it traverses in the Y direction across build bed 50. Material coater 74 may include a blade or doctor to level the deposited build material 72.

Waveguide 10 can traverse back and forth along the X direction with multiple scans and also along the Y direction at multiple Y-direction positions after the build material 72 is laid down by the material coater 74. In some examples, the waveguide 10 may also be controlled along the Z-direction during processing to modify a spot size of the fused material and possibly material properties. This Z-direction control allows for delivering a high electric field energy (and possibly high magnetic fields in other embodiments of the waveguide 10) to the build material in regions of lateral dimensions of sizes dependent upon the tip height. A processor 60 is coupled with non-transitory CRM 62 that includes multiple software modules with instructions 61 to control the position of the tip 17 of the coaxial concentrator of waveguide 10 about the X-Y plane 76, the deposition of the build material 72 using a material coater 74, the control of MW energy from MW source 32, and analysis of the difference signal 45 that represents the reflected signal 39 with respect to the excitation MW signal 38 from MW source 32. For instance, there may be a position control module 63 for controlling the material coater 74 and waveguide 10 across the build bed 50 in the X-Y plane 76. The position control module 63 may also in some examples control the height of the build bed 50 in the Z direction, typically by lowering the build bed 50 to allow deposition of a new build layer. The control module 63 may also control the height of the tip 17 of the coaxial concentrator 16 relative to a layer of build material 72.

Accordingly, the example 3D printing system 70 may include an X-Y-Z translation device 80 wherein the waveguide 10 is configured to move in an X-Y plane 76 and the powdered build material 72 is distributed in the X-Y plane 76 and allowed to move in a Z direction, wherein a tip 17 of the coaxial concentrator 16 provides a high electric field energy 20 with negligible magnetic field in the X-Y plane 76 in about 1/1000 of the wavelength of the MW buffered signal 35 up to a depth of about 100-200 micrometers in the Z direction.

In some examples, a far-field I/R probe 48, for example, a FLIR (forward looking infra-red) probe, may be directed near the tip 17 of the coaxial concentrator 16 to provide a temperature measurement of the build material 72 during the fusion process. A characterization module 67 may be used to correlate an output of the far-field I/R temperature probe 48 with a concurrent phase 26 and amplitude 24 of the difference signal 45 to allow for an additional inferred near-field temperature monitoring using the difference signal 45. That is, a FLIR response is fairly slow in response. However, by using the phase 26 and amplitude 24 data in conjunction with the FLIR output, more timely information is available from the inferred near-field temperature monitoring of the fusion process, thereby allowing detection of thermal runaway and plasma discharge events, which may occur rapidly, to be managed. Various materials show different dependence on the amplitude 24 and phase 26 differences of the difference signal 45, so the characterization module may keep a correlation table for the build material 72 and likewise for other build materials 72 that may be used.

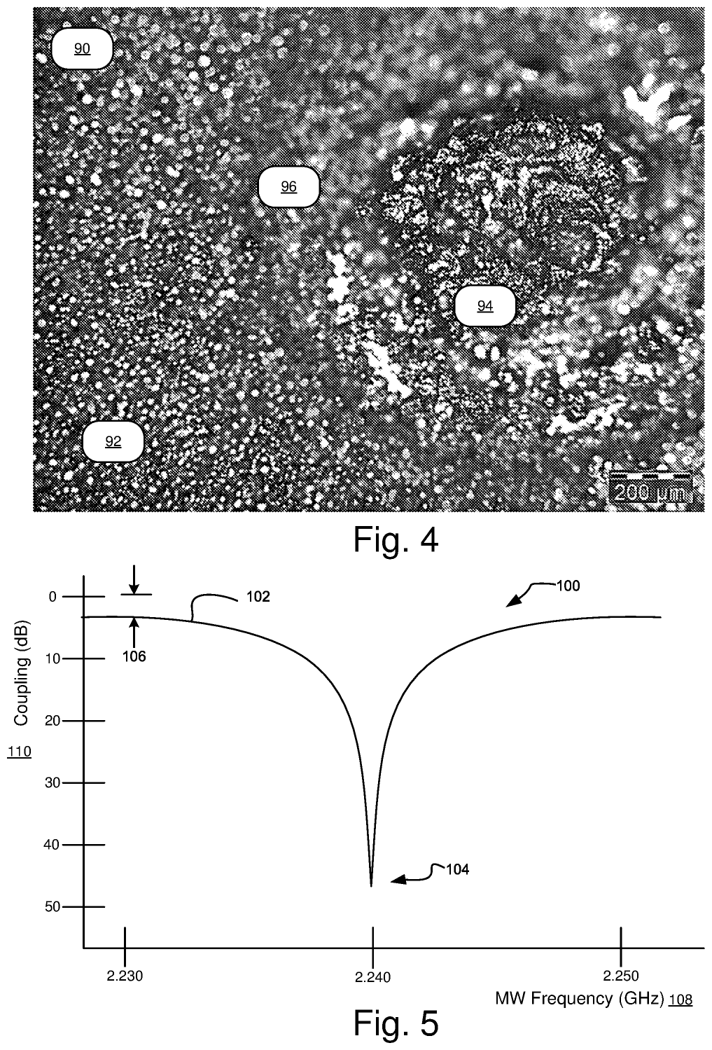

FIG. 4 is an image 90 of a layer of metal powder 92 (in this example, a stainless steel powdered build material 72) and an example application of a spot MW energy delivered by a high electric field 20 from tip 17 to create an example fused area 94 with about a 500-micrometer radius. The layer of metal powder 92 represents a powdered material state. Between the fused area 94 and the metal powder 92 is a sintered or non-liquified state. The fused area 94 represents a full melt or fused state.

FIG. 5 is a graph 100 of an example S₁₁ reflection profile 102 with coupling 110 vs. MW frequency 108 for the example waveguide 10 shown in FIG. 1 based on empirical results. S₁₁ represents how much power is reflected from the waveguide 10 at the input port connector 13 and is known as the reflection coefficient, gamma, or return loss. An S₁₁ of 0 dB means that all the power applied to the waveguide 10 is reflected from the waveguide 10. Part of the energy applied to the waveguide 10 is radiated at tip 17 from the coaxial concentrator 16 and part is absorbed as losses within the waveguide 10. This absorption and is also known as insertion loss 106. As the MW buffered signal 35 is coupled to the transmitting antenna 12 and swept from about 2.230 GHz to 2.250 GHz, there is a small insertion loss 106 of about 3 dB for the MW buffered signal 35 at the frequency extremes and an excellent coupling efficiency of about 48 dB at the 2.24 GHz notch at the frequency for excitation signal 38. Accordingly, the design of the waveguide 10 with a center based coaxial concentrator 16 and tuned for frequency and impedance provides for an excellent transmission efficiency with minimal insertion loss and high selectivity of the excitation signal 38.

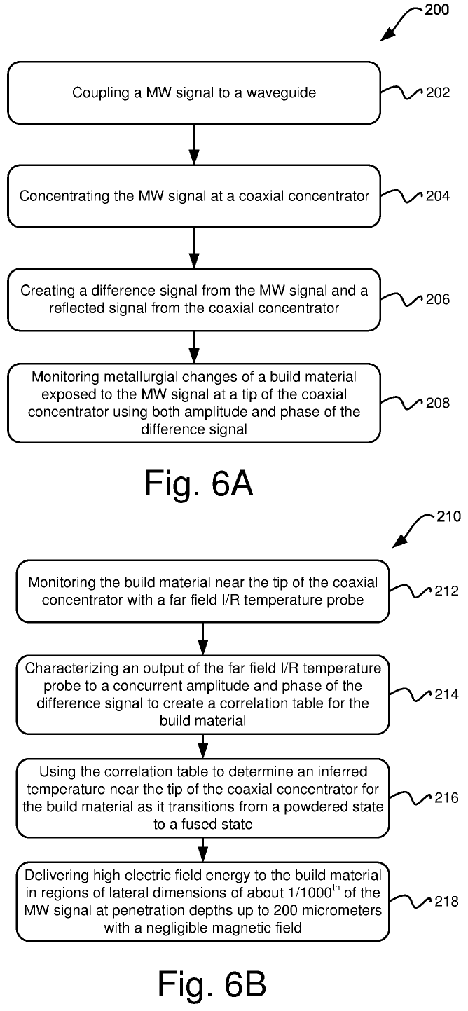

FIG. 6A is a flowchart of an example method 200 for near-field monitoring of energy delivery. In block 202, the method 200 includes the operation of coupling a MW buffered signal 35 to a waveguide 10. In block 204, the method 200 includes the operation of concentrating the MW buffered signal 35 at a coaxial concentrator 16. The method 200 continues in block 206 by creating a difference signal 45 from the MW buffered signal 35 and a reflected signal 39 from the coaxial concentrator 16. In block 208 the method 200 includes the operation of monitoring material changes of a build material 72 exposed to the MW buffered signal 35 at a tip 17 of the coaxial concentrator 16 using one of an amplitude 24 and a phase 26 of the difference signal 45.

FIG. 6B is a flowchart of additional operations 210 which may be included in the example method 200 of FIG. 6A. For instance, in block 212, the build material 72 near the tip 17 of the coaxial concentrator 16 may be monitored with a far-field I/R temperature probe 48. In block 214, an output of the far-field I/R temperature probe 48 may be characterized with a concurrent amplitude 24 and phase 26 of the difference signal 45 to create a correlation table for the build material 72. In block 216, the correlation table may be used to determine an inferred temperature near the tip 17 of the coaxial concentrator 16 for the build material 72 as it transitions from a powdered state to a fused state. In some examples, the high electric field energy 20 may be delivered to the build material 72 in regions of lateral dimensions of about 1/1000^{th} of the MW signal at penetration depths up to 200 micrometers with a negligible magnetic field. The penetration depth may be dependent on thermal conduction properties of the build material 72 and in some examples, may be about 100-200 micrometers.

The various examples of operations described herein may include logic or several components, modules, or constituents. Modules may constitute either software modules, such as code embedded in a tangible non-transitory machine or computer-readable medium 62 executed as instructions 61 on processor 60 or implemented partially with hardware modules. A hardware module is a tangible unit capable of performing certain operations and by be configured or arranged in certain manners. In one example, one or more computer systems or one or more hardware modules of a system 30 or 3D printing system 70 may be configured by software (e.g., an application, or portion of an application) as a hardware module that operates to perform certain operations as described herein.

In some examples, a hardware module may be implemented as electronically programmable using microcode stored in computer-readable medium 62. For instance, a hardware module may include dedicated circuitry or logic that is permanently configured (e.g., as a special-purpose processor, state machine, a field programmable gate array (FPGA) or an application specific integrated circuit (ASIC) to perform certain operations. A hardware module may also include programmable logic or circuitry (e.g., as encompassed within a general-purpose processor 60 or another programmable processor) that is temporarily configured by software to perform certain operations.

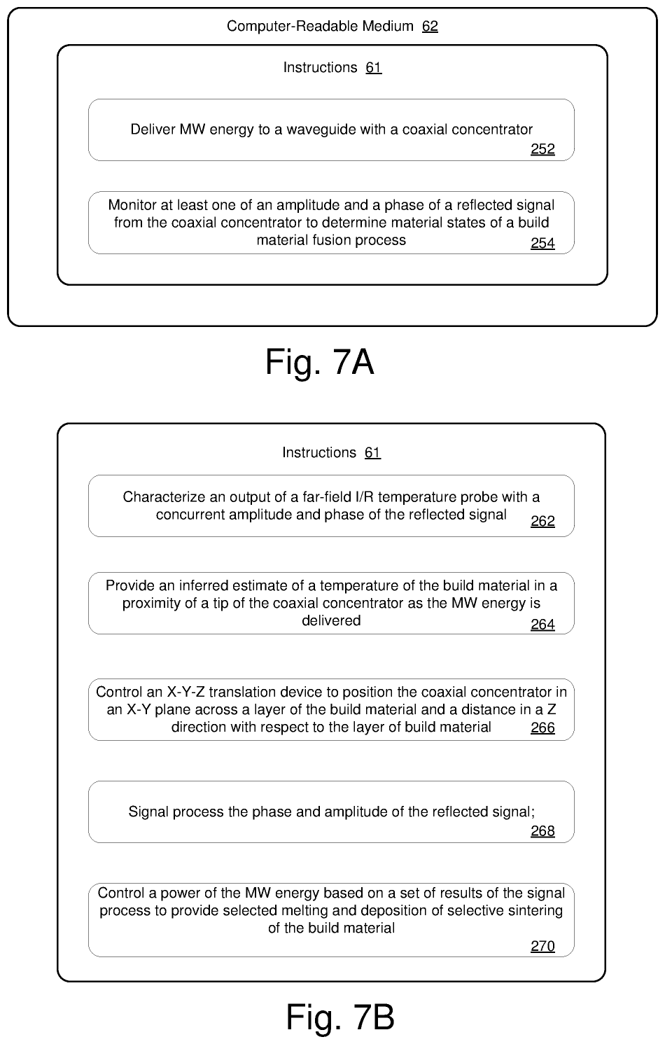

FIG. 7A is a block diagram of example instructions 61 for a non-transitory computer-readable medium 62. An energy control module 65 may include instructions 61 to cause the processor 60 to deliver MW energy as MW buffered signal 35 to a waveguide 10 with a coaxial concentrator 16 as in block 252. In block 254, the instructions 61 may cause the processor 60 to monitor at least one of an amplitude 24 and a phase 26 of a reflected signal 39 from the coaxial concentrator 16 to determine material characteristics of a build material 72 fusion process. For instance, the material characteristics may include at least one of a build material fusion state, and a temperature of the build material 72 in proximity to the coaxial concentrator 16.

FIG. 7B is a block diagram of additional example instructions 61 for the computer readable medium 62 of FIG. 7A. A characterization module 67 may include instructions as in block 262 to cause the processor 60 to characterize an output of a far-field I/R temperature probe 48 with a concurrent amplitude 24 and phase 26 of the reflected signal 39. Also, in block 264, the characterization module may include instructions 61 to cause the processor 60 to provide an inferred estimate of a temperature of the build material 72 in a proximity of a tip 17 of the coaxial concentrator 16 as the MW energy in MW signal 45 is delivered. A position control module 63 may include instructions 61 to cause the processor 60 to control an X-Y-Z translation device 80 to position the coaxial concentrator 16 in an X-Y plane 76 across a layer of the build material 72 and a distance in a Z direction with respect to the layer of build material 72 as in block 266. A signal analyzer module 66 in blocks 268 and 270 may include instructions 61 to cause the processor 60 to signal process at least one of the amplitude 24 and phase 26 of the reflected signal 39 to create a set of results and to control with power control signal 36 a power of the MW energy of MW buffered signal 35 based on the set of results of the signal processing to provide selected melting and deposition for selective sintering of the build material. Deposition control module 64 may include instructions 61 to allow the processor 60 to move the build be 50 downward in the Z direction to allow the material coater 74 to deposit a uniform layer of build material 72 across the build bed 50 in the Y direction all along the X direction in the X-Y plane 76. The creation of the 3D build object 82 is performed by repetition of the deposition control module 64 instructions, the position control module 63 instructions, the energy control module instructions, and the signal analyzer module 66 instructions. The characterization module 67 instructions may be just performed during a calibration or maintenance cycle to create an up to date characterization table for the current build material 72. The I/R probe 48 may be used in characterization and also as an additional sensor input in the fusion process.

FIG. 8 is a graph 300 showing example relative amplitude 24 and phase 26 changes of a difference signal 45 during different fusion process states 310. The actual amplitude 24 and phase 26 changes will vary depending on the actual build material 72 used. Metal or high dielectric materials may have higher amplitudes and lesser phase changes. Also, the size and shape of the build material 72 may also affect the relative amplitude 24 and phase 26 levels. For illustrative purposes only and not meant to be limiting, the amplitude 24 changes are shown in solid line 302. The phase 26 changes are shown with the dotted line 304.

For a metal powdered material, the excitation signal 38 is coupled to tip 17 to create the high electric field 17. Due to the powdered nature of the metal material, the electric field will be scattered, and the amplitude 24 will be low for the reflected signal 39. For a non-metal powdered material, the dielectric constant of the powder will be closer to the dielectric constant of air and less than the dielectric constant of a solid form of the non-metal powdered material. Accordingly, the impedance of the waveguide 10 will change only a bit, and the amplitude 24 will be low and the phase difference 26 large. As the MW energy is absorbed by the powdered material, it begins to coalesce and come together to form one porous mass or whole in a sintered state without liquification. Thus, for a metal powder, there still may be a rough surface and multiple reflections. For a non-metal powder, the dielectric constant may not yet equal that of a solid mass due to porosity and surface variations. However, for the sintered state, the reflection signal 39 will have a higher amplitude 24 than when in the powdered state and will vary in a generally monotonic manner from the powdered state to the sintered state. Similarly, as there are fewer reflections for metal and higher dielectric constant for non-metal powders, the phase 26 will generally decrease monotonically to a level between the large and intermediate levels, perhaps with some jitter as the coalescence of the build material 72 occurs.

As more MW energy is applied, the temperature of the build material in the location of the high electric field 20 will increase to cause the build material 72 in that location to liquify and melt creating a more uniform and flatter surface. For a metal build material 72, this increases the amplitude 24 of the reflected signal 38 to a high level and the phase 26 to an intermediate level. As even more MW energy is applied, the temperature at the spot increases but the amplitude 24 of the reflected signal 39 remains close to that of the melted state. However, there may be a sudden change in phase 26 due to dielectric changes to a small level.

If too high a power level for the MW energy is used or for too long, there may be a corona discharge between the tip 17 and the iris 22 or the tip 17 and build material 72. This corona discharge may occur either due to a charge build-up on the build material 72, vapors from the build material changing the air permittivity or resistance such that a direct current can flow from the tip. This corona discharge alters the characteristic impedance of the waveguide 10 and causes a sudden large increase in amplitude 24 of the reflection signal 39 from the end of the coaxial concentrator 16 as if shorted resulting in a maximum reflection (less the insertion loss). Similarly, as the reflected signal 39 would behave as if the coaxial concentrator 16 tip 17 were shorted, the phase difference 26 would also suddenly decrease to a minimum level.

In addition, an inferred temperature may be predicted as well as the thermodynamic state of the local build material 72 near the tip 17. The temperature will generally rise in proportion to the amplitude 24 of the reflected signal 39. Once the amplitude 20 begins to level out, the spot build material 72 is transitioning from a solid to a liquid state and is then at the transition temperature of the build material 72. When thermal runaway occurs, a larger spot size of the build material will form increasing the amount of melted material, and hence a larger amplitude 24 signal with even less phase difference 26 due to the radius squared effect of the rapidly increasing spot size area minimizing scattering from the adjacent powdered material.

In summary, the described waveguide 10 with a coaxial concentrator 16 may be used to precisely deliver MW energy into small spot areas (less than about 1/1000 of a wavelength of the excitation signal 38) from a compact source with high electric fields and minimal magnetic fields. This allows for a broad range of build materials 72 as well as low power operation. The penetration depth can be more controlled than with laser systems and is only limited by heat conduction of the build material 72 used. The waveguide 10 may be made even smaller by using high dielectric materials within the waveguide to shrink dimensions for a particular MW frequency of excitation signal 38. The resulting structure can be made with a relatively low cost for parts. The structure and associated circuitry allow for the ability to monitor a spot of build material 72 via a reflected signal 39 by measuring an amplitude 20 and phase difference 26 at the build material 72 surface locally (near-field) rather than with remote far-field devices that are difficult to get fine resolution. The monitoring of the reflected signal 39 allows for the determination of various process states, inferred temperature, and thermodynamic phase transition changes of the build material 72 as it transitions from powdered to sintered to melted states.

While the claimed subject matter has been particularly shown and described with reference to the foregoing examples, those skilled in the art will understand that many variations may be made therein without departing from the intended scope of subject matter in the following claims. This description should be understood to include all novel and non-obvious combinations of elements described herein, and claims may be presented in this or a later application to any novel and non-obvious combination of these elements. The foregoing examples are illustrative, and no single feature or element is to be used in all possible combinations that may be claimed in this or a later application. Where the claims recite “a” or “a first” element of the equivalent thereof, such claims should be understood to include incorporation of one or more such elements, neither requiring nor excluding two or more such elements.

What is claimed is:

1. A method of near-field monitoring of energy delivery, comprising:
coupling a microwave (MW) signal to a waveguide;
concentrating the MW signal at a coaxial concentrator;
creating a difference signal from the MW signal and a reflected signal from the coaxial concentrator; and
monitoring material changes of a build material exposed to the MW signal at a tip of the coaxial concentrator using one of an amplitude and a phase of the difference signal.

2. The method of claim 1, further comprising monitoring the build material near the tip of the coaxial concentrator with a far-field I/R temperature probe.

3. The method of claim 2, further comprising characterizing an output of the far-field I/R temperature probe to a concurrent amplitude and phase of the difference signal to create a correlation table for the build material.

4. The method of claim 3, further comprising using the correlation table to determine an inferred temperature near the tip of the coaxial concentrator for the build material as it transitions from a powdered state to a fused state.

5. The method of claim 1, further comprising delivering high electric field energy to the build material in regions of lateral dimensions of about 1/1000^{th} of the MW signal at penetration depths up to 200 micrometers with a negligible magnetic field.

6. A system for near-field monitoring of energy delivery, comprising:
a waveguide coupled to a microwave (MW) source at a transmitting antenna and the waveguide further including a receiving antenna coupled to a coaxial concentrator;
a heterodyne circuit coupled to the MW source and the transmitting antenna to create a difference signal between the MW source and the transmitting antenna that represents a reflected signal from the receiving antenna; and
an amplitude and phase detector coupled to the difference signal and configured to output an analysis of a powdered build material various material states during a fusion process.

7. The system of claim 6, further comprising:
a far-field I/R temperature probe directed near a tip of the coaxial concentrator; and
a characterization module to correlate an output of the far-field I/R temperature probe with a concurrent phase and amplitude of the difference signal to allow for an inferred near-field temperature monitoring using the difference signal.

8. The system of claim 6, further comprising:
an X-Y-Z translation device wherein the waveguide is configured to move in an X-Y plane and the powdered build material is distributed in the X-Y plane and allowed to move in a Z direction, wherein a tip of the coaxial concentrator provides high electric field energy with negligible magnetic field in the X-Y plane in about 1/1000 of the wavelength of the MW signal up to a depth of about 200 micrometers in the Z direction.

9. The system of claim 6, wherein the coaxial concentrator has an iris that is adjustable to different orifice sizes.

10. The system of claim 6, wherein the MW source has a power of less than about 200 W and is coupled to the coaxial concentrator with an insertion loss of less than about 0.3 dB and a coupling of greater than about 40 dB.

11. A non-transitory computer-readable medium for monitoring near-field energy delivery, comprising instructions that when read and executed by a processor cause the processor to:
deliver a MW signal to a waveguide with a coaxial concentrator; and
monitor at least one of an amplitude and a phase of a reflected signal from the coaxial concentrator to determine material characteristics of a build material fusion process.

12. The non-transitory computer-readable medium of claim 11, further comprising instructions to cause the processor to:
characterize an output of a far-field I/R temperature probe with a concurrent amplitude and phase of the reflected signal; and
provide an inferred estimate of a temperature of the build material in a proximity of a tip of the coaxial concentrator as the MW signal is delivered.

13. The non-transitory computer-readable medium of claim 11, further comprising instructions to cause the processor to control an X-Y-Z translation device to position the coaxial concentrator in an X-Y plane across a layer of the build material and a distance in a Z direction with respect to the layer of build material.

14. The non-transitory computer-readable medium of claim 11, further comprising instructions to cause the processor to:
signal process at least one of the amplitude and the phase of the reflected signal; and
control a power of the MW signal based on a set of results of the signal process to provide selected melting and deposition for selective sintering of the build material.

15. The non-transitory computer-readable medium of claim 11, wherein the material characteristics include at least one of a build material fusion state and a temperature of the build material in proximity to the coaxial concentrator.
